(19) United States
(12) Patent Application Publication
(10) Pub. No.: US 2026/0246263 A1
(43) Pub. Date: Aug. 20, 2026

(54) SURGE PROTECTOR

(71) Applicant: Robert Albert Dawley, Archer Lodge, NC (US)

(72) Inventor: Robert Albert Dawley, Archer Lodge, NC (US)

(21) Appl. No.: 19/053,604

(22) Filed: Feb. 14, 2025

(51) Int. Cl. H02H 9/04; H02H 1/00; H02H 7/125; H02H 9/00

(52) U.S. Cl. CPC H02H 9/04; H02H 1/0007; H02H 1/0061; H02H 7/125; H02H 9/005

(57) ABSTRACT

A surge protector detects surge events using a rate of change detection circuit, which evaluates the rate of change of current through a monitored conductive element that serves as a defined load that is connected in parallel with an output load that is fed by the current. The initial surge-induced current is conducted through the conductive element, and when the rate of change of current is indicative of surge conditions, additional electronic loads are connected to absorb the surge energy and/or clamp the surge voltage.

### CROSS-REFERENCE TO RELATED APPLICATION

This application claims the benefit of U.S. Provisional Patent Application No. 63/650,963, filed May 23, 2024, which is incorporated by reference herein in its entirety.

### TECHNICAL FIELD

The present disclosure relates to surge protectors.

### BACKGROUND

Previously disclosed “series type” or “series mode” surge suppressor technologies have generally been effective and reliable when used in the field, and have proven to be valuable tools to the professional and consumer alike for protecting costly and sensitive electronic equipment.

In one example, a voltage surge causes an increase in the charge stored on an electrolytic capacitor. If the rate of change of the charge is sufficient to propagate through a high pass filter circuit, additional capacitors are operatively connected to absorb the surge energy. A disadvantage is that the detection of a surge event is delayed by the time required to increase the charge on the capacitor. Surges are extremely fast transient events, and any delay in detection can have negative consequences for connected equipment.

In another example, a surge detection circuit is positioned on an input (supply) side of a series inductor, with connections to both alternating current (AC) input conductors (e.g., AC line and neutral conductors). If a rate of change of the supply voltage on the input conductors is sufficient to propagate through a high pass filter circuit, additional capacitors are operatively connected to absorb the surge energy. A disadvantage is that components of the high pass filter detection circuit must be properly sized and rated for connection across an AC supply.

A disadvantage common to both of the previously cited examples is the requirement for one or more high pass filter stages as part of the surge detection mechanism. Such a filter may add additional requirements, complexity, and parts count.

### BRIEF DESCRIPTION OF THE DRAWINGS

FIG. 1 is a high-level block diagram of an example surge protector according to an embodiment.

FIG. 2 is a block diagram of an example surge protector that employs a diode bridge, according to an embodiment.

FIG. 3 is a circuit diagram of an example surge protector in which a capacitor serves as a monitored conductive element (also referred to as a “defined load”) and an inductor serves as a current rate of change detector, according to an embodiment.

FIG. 4 is a circuit diagram of another example surge protector in which a diode or varistor serves as the monitored conductive element, according to an embodiment.

FIG. 5 is a circuit diagram of another example surge protector in which a capacitor serves as the monitored conductive element, and a processing and trigger generation block incorporates a microcontroller or integrated circuit and an optional opto-isolator, according to an embodiment.

FIG. 6 is a circuit diagram of another example surge protector in which the monitored conductive element is positioned on a supply side of the inductor, and the processing and trigger generation block incorporates an opto-isolator, according to an embodiment.

FIG. 7 shows a surge response using a prior art surge protector.

FIG. 8 shows a surge response using the surge protector of FIG. 3.

FIG. 9 is a block diagram of an example controller configured to implement embodiments presented herein.

### DESCRIPTION OF EXAMPLE EMBODIMENTS

### Overview

Embodiments presented herein are directed to a surge protector that detects surge events using a rate of change detection circuit, which evaluates the rate of change of current through a monitored conductive element that serves as a defined load that is connected in parallel with an output load that is powered by the current. The initial surge-induced current is conducted through the conductive element, and when the rate of change of current is indicative of surge conditions, additional electronic loads are connected to absorb the surge energy and/or clamp the surge voltage.

### Example Embodiments

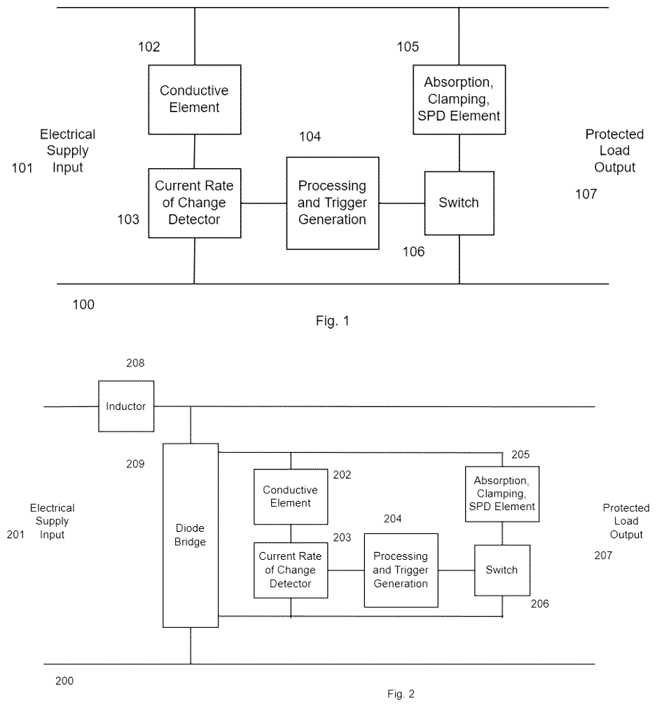

FIG. 1 is a high-level block diagram of an example surge protector 100 according to an embodiment. Surge protector 100 includes two electrical power supply conductors (i.e., opposing power rails) that supply or carry power from an electrical supply input 101 connected to input ends of the power rails to an output load 107 that is connected across output ends of the power rails. Electrical supply input 101 may supply AC power or DC power to the power rails. Surge protector 100 includes circuit components connected between (i.e., across) across the power rails in parallel with output load 107. The circuit components include a conductive element (also referred to as a “defined load”) 102, a current rate of change detector 103, a processing trigger generator 104, a switch 106, and an absorption, clamping, and/or surge protection device (SPD) element 105.

Conductive element 102 (i.e., the defined load) is connected between/across the power rails. Therefore, conductive element 102 is connected in parallel with output load 107. Conductive element 102 may include a capacitor, a resistor, a varistor (e.g., a metal oxide varistor (MOV)), a diode (e.g., a silicon avalanche diode (SAD), a transient voltage suppression diode (TVS), or a silicon diode for alternating current (SIDAC), a gas discharge tube (GDT), or some combination thereof. The defined load represents a known fixed load (i.e., a predetermined load) that provides a consistent response to surge events. This is in contrast to output load 107 which may be unknown and varying over time (and therefore draws varying currents) depending on varying condition/configurations of the output load.

Current rate of change detector 103 is connected in series with conductive element 102. The current rate of change detector can be a voltage measurement or a current measurement, or some combination thereof. For example, the current rate of change detector 103 may provide a voltage measurement of the voltage developed across the terminals of an inductor which is connected in series with the conductive element. An inductor's I-V relationship (V_{L}=L di/dt) allows for a straight-forward voltage measurement to detect rapid changes in current.

Processing and trigger generation block 104 is configured to evaluate the output of the current rate of change detector 103 and generate one or more triggers if/when a set of criteria are met. The criteria may include one or more thresholds for a minimum rate of change of current, a maximum rate of change of current, a time duration during which the rate of change of current exceeds one or more of the thresholds, an application of hysteresis when transitioning between “surge not detected” and “surge detected” states, or some combination of these.

The trigger(s) output by processing and trigger generation block 104 are connected to one or more switches 106, and are used to control the switch(es) between non-conductive and conductive states. The switch(es) may be thyristors (SCR, TRIAC, DIAC, QUADRAC), transistors (bipolar, MOSFET, IGBT), or electromechanical (relay, contactor), for example.

Switch(es) 106 connect and disconnect additional electronic elements 105 to absorb, dissipate, and/or clamp on the surge energy and voltage. These elements may be capacitors, resistors, varistors, diodes, gas tubes, or some combination thereof, for example. There are benefits of selectively connecting surge handling elements only when a surge is detected, for example: an uncharged (or minimally charged) capacitor will present a very low impedance to the surge; a varistor (or diode or gas tube) may be employed with a lower clamping voltage than a component which is permanently connected; the lifetime of the elements will be extended; and the duration of connection and conduction may be controlled.

FIG. 2 is a block diagram of an example surge protector 200, according to an embodiment. In the example of FIG. 2, surge protector 200 includes an inductor 208 (i.e., a “series inductor”) connected in-line with one of the power rails such that AC or DC electrical power is supplied from electrical supply input 201 to output load 207 though the series inductor. Remaining components of surge protector 200 are connected across the power rails after series inductor 208 but before output load 207, i.e., downstream from the series conductor but upstream from the output load. The remaining components include a diode bridge 209 to rectify the AC power and to deliver rectified power to the further components of the surge protector, which operate on the rectified power. The further components include a conductive element (i.e., the “defined load”) 202, a current rate of change detector 203, a processing trigger generator 204, a switch 206, and an absorption, clamping, and/or SPD element 205.

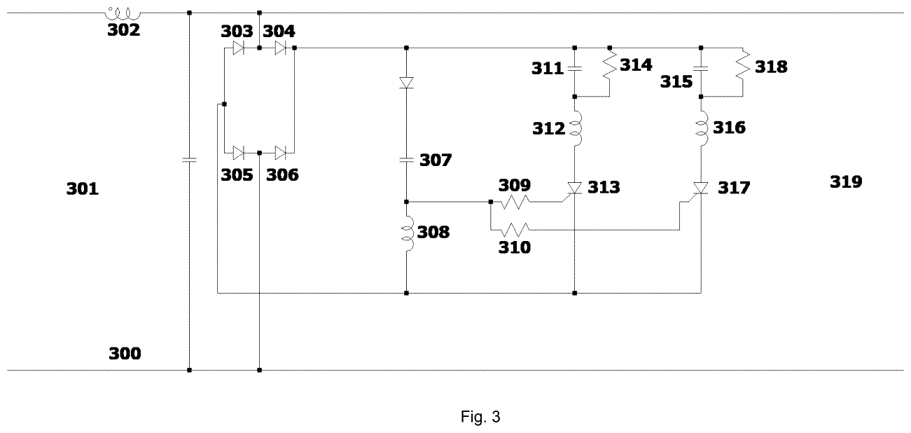

FIG. 3 is a circuit diagram of an example surge protector 300 similar to example surge detector 200. In the example of FIG. 3, an inductor 302 (similar to inductor 202) is connected in series between electrical supply input 301 and an output load 319 (i.e., equipment to be powered and protected). Capacitor 307 (i.e., the defined load) is kept charged to the peak of the supply voltage through diodes 303-306 of a full-wave bridge rectifier. The full-wave bridge rectifier configuration of the diodes is chosen so that surges of either polarity (when the first supply conductor is positive with respect to the second supply conductor, or when the second supply conductor is positive with respect to the first supply conductor) will consequently cause current flow through capacitor 307 and inductor 308, which is configured in series with capacitor 307.

When a surge is present between the power rails, current flows through inductor 302, two or more diodes within the set 303-306, capacitor 307, and inductor 308. A voltage across inductor 308 is created as the inductor resists the change in current per the relationship, V_{L}=L di/dt. A faster-changing current, such as would occur during a surge event, will result in a greater amplitude voltage appearing across inductor 308 than a more slowly-changing current, such as would result from slower variations in the supply voltage. This property inherent to inductors allows for fast surge events to be differentiated from non-surge conditions with a simple amplitude measurement. Since the rate of change of surge current is relevant to the embodiments, and not the amount or amplitude of conducted surge current, a range of capacitance values is adequate for capacitor 307 to serve as the defined load.

A processing and trigger generation circuit is formed by resistors 309 and 310, which are configured to provide current to the gating terminals of electronic power semiconductor switches; in the presently described example configuration, Silicon Controlled Rectifiers (313 and 317) are chosen. The values of inductor 308, resistor 309, and resistor 310 are selected such that current sufficient to cause SCRs 313 and 317 to transition to a conducting state is only supplied when the amplitude of the voltage across inductor 308 exceeds some target threshold. In this way, the embodiments may be adjusted and configured to detect and respond to different surge characteristics.

In normal operation (i.e., when no surges are present), there is no or minimal voltage across inductor 308; therefore, 313 and 317 are turned Off. On the other hand, when a surge is present, there is a voltage across inductor 308, which will create current through resistors 309 and 310, delivering gating current to 313 and 317, turning them On.

When SCRs 313 and 317 are turned On, capacitors 311 and 315, normally kept uncharged or minimally charged, are connected to the surge current path. The low impedance of this capacitive load sinks the surge current, using its energy to increase the charge on the capacitors. When the surge event is over, resistors 314 and 318 will bleed-off the charge. In the example of FIG. 3, inductors 302, 312, and 316 serve as current limiters, protecting the switching elements from exceeding their physical tolerances.

Other types of components may form the conductive element (i.e., the defined load), such as an MOV, a diode (e.g., SAD, TVS, SIDAC, or other diode type), or a GDT, for example.

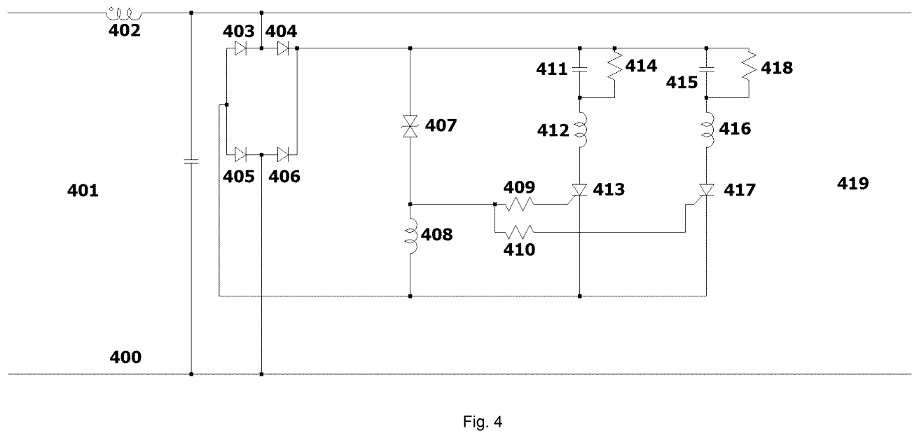

FIG. 4 is a circuit diagram of another example surge protector 400 using a TVS diode 407 connected to the current rate of change detector instead of a capacitor.

Some of the embodiments described above use an inductor to detect the rate of change of current. It is understood that there are other ways to implement the current rate of change detector, including, but not limited to, current sense resistors, current transformers, and current sense transducers (Hall Effect sensors, etc.), for example. Various measurement networks may be incorporated into the detector, depending on the desired characteristics. For example, resistors and resistor dividers can serve to scale the measured signal.

Many options exist for processing the output of the current rate of change detector, and for generation of the switching trigger signals, as described below.

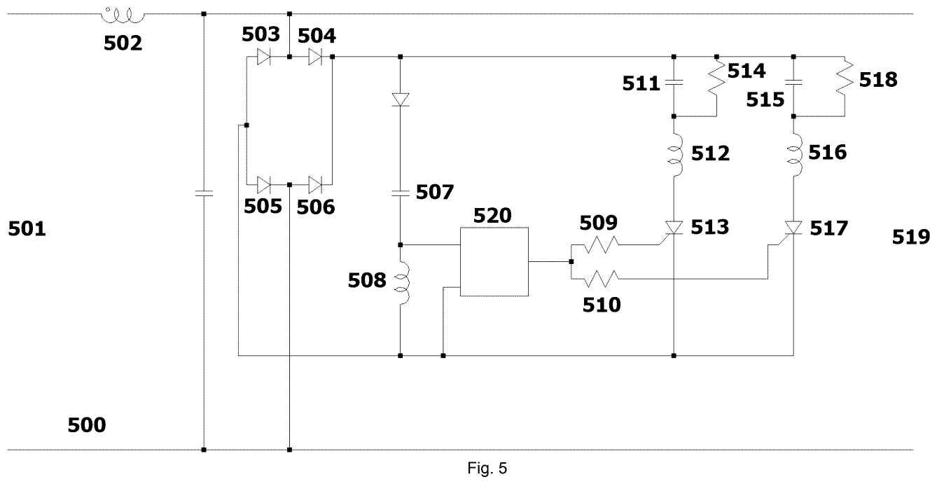

FIG. 5 is a circuit diagram of an example surge protector 500 in which a capacitor serves as the conductive element, and the processing and trigger generation block incorporates a microcontroller or integrated circuit and an optional opto-isolator (520). The rate of change detector output is input to the integrated circuit or microcontroller. This device may contain specialized circuits or digital instructions which may, for example, measure an amplitude of a measured voltage signal and compare it to pre-defined thresholds for a more accurate detection of a surge event. The microcontroller/IC may further be configured or constructed to output a trigger signal with specific timing characteristics.

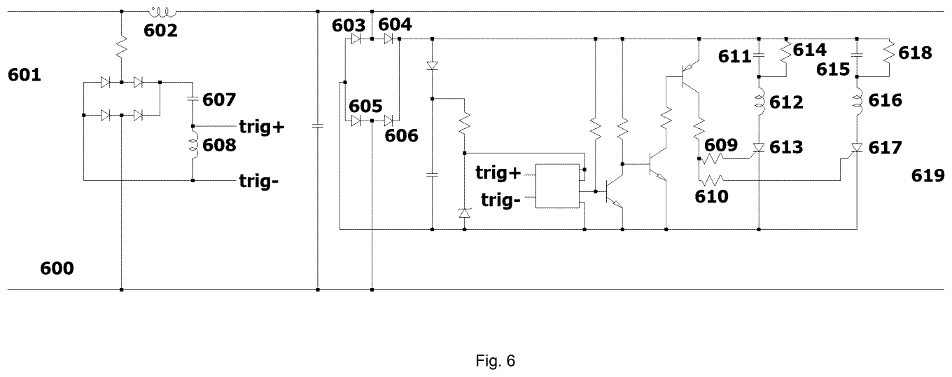

FIG. 6 is a circuit diagram of an example surge protector 600 in which a conductive element 607 is positioned on the supply side of series inductor 602, and the processing and trigger generation block (on the output load side of the series inductor) incorporates an opto-isolator. Optical isolation allows for the safe separation of the conductive element and processing blocks in different parts of the surge protective system that may not share a common reference.

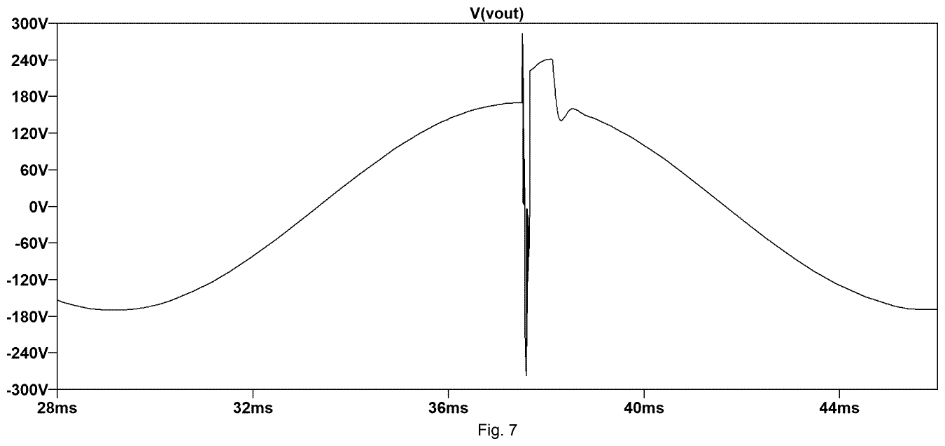

FIG. 7 shows a surge response using a prior art surge protector.

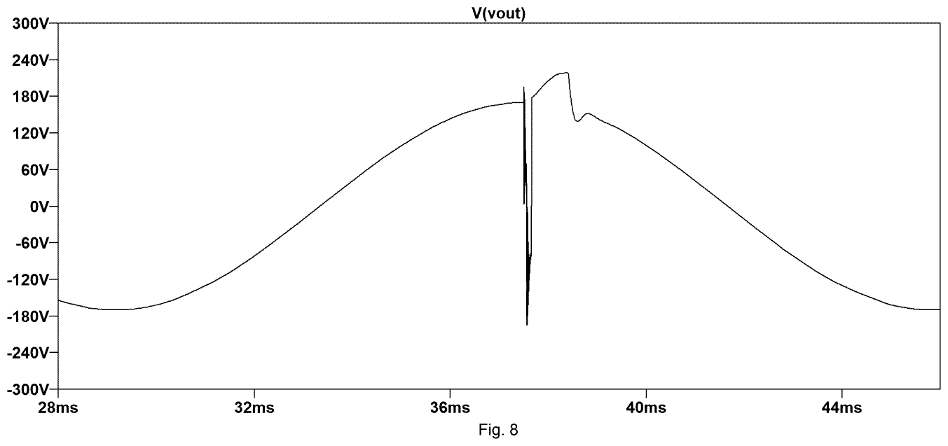

FIG. 8 shows a surge response using the surge protector of FIG. 3.

Various embodiments of a surge protector are presented herein, as described above and below.

In an embodiment, a surge protector comprises:
a. a conductive element which is configured between/across two electrical power supply conductors (power rails) that supply power to an output load also connected across the power rails so as to be connected in parallel with the output load.
b. an optional diode bridge.
c. a surge detection circuit including a component to detect a rate of change of current through the conductive element.
d. a detector to detect a rate of change of current.
e. a generator to generate one or more switching control signals.
f. one or more switches controlled responsive to the one or more switching control signal(s) to control the switches into conductive, non-conductive, and/or semi-conductive states.
g. the switches are configured to connect one or more electronic components in a conductive path between the two electrical power supply conductors.

The conductive element may include any of one or more capacitors, one or more diodes, one or more varistors, one or more resistors, and/or one or more gas discharge tubes.

The one or more switches may include any of a Thyristor (SCR, TRIAC, DIAC, QUADRAC, etc.), a Transistor (Bipolar, MOSFET, IGBT, etc.), and/or electromechanical (relays, contactors, etc.).

The current rate of change detection circuit may include an inductor.

The surge protector may further include a series inductor connected in series with at least one of the electrical power supply conductors.

The surge protector may further include the diode bridge connected to the two electrical power supply conductors on the load side of the series inductor, such that the monitored conductive element, surge detection circuit, processing and control signal generating means, switches, and controlled components are connected between the positive and negative terminals of the diode bridge.

The current rate of change detection circuit may include a microcontroller or integrated circuit.

The surge protector may further include an isolator (e.g., an optical isolator, RF isolator, pulse transformer, etc.) to couple the switching control signal(s) to the one or more switch.

In another embodiment, a method for protecting electrical and electronic devices from a voltage surge comprises:
a. connecting a conductive element between two electrical power supply conductors.
b. connecting one or more controlled electronic components between two electrical power supply conductors.
c. connecting switch(es) in series with the controlled components.
d. determining a rate of change of current through the conductive element.
e. comparing the rate of change to a set of criteria.
f. controlling the switch(es) to connect one or more of the controlled electronic components in a conductive path between the two electrical power supply conductors if the comparison of the rate of change satisfies the criteria.

In another embodiment, a surge protector for power supplied on power rails from a power input to an output load that is connected across the power rails and that is downstream from the power input, comprises:
a. first series-connected components including a defined load and a surge detector connected between the rails to be in parallel with the output load, wherein the surge detector is configured to derive a rate signal indicative of a rate of change of current that flows through the defined load.
b. second series-connected components including a surge reducer and a switch connected between the rails.
c. a controller to control the switch responsive to the rate signal to:
   i. when the rate signal is in a range indicative of a power surge, control the switch to enable the surge reducer to reduce the power surge.
   ii. when the rate signal is not in the range, control the switch to disable the surge reducer.

The surge protector further comprises a diode bridge connected across the rails to convert AC power at the power input to rectified power, and to produce rectified power to opposing terminals of the diode bridge, wherein the surge protector is connected to the opposing terminals and configured to operate on the rectified power.

The surge protector may further include an inductor connected in-line with one of the rails, and remaining components of the surge protector are connected between the inductor and the output load.

The surge protector may further include an inductor connected in-line with one of the rails between the power input and the output load, and the defined load and the surge detector are connected in series with each other between the inductor and the output load.

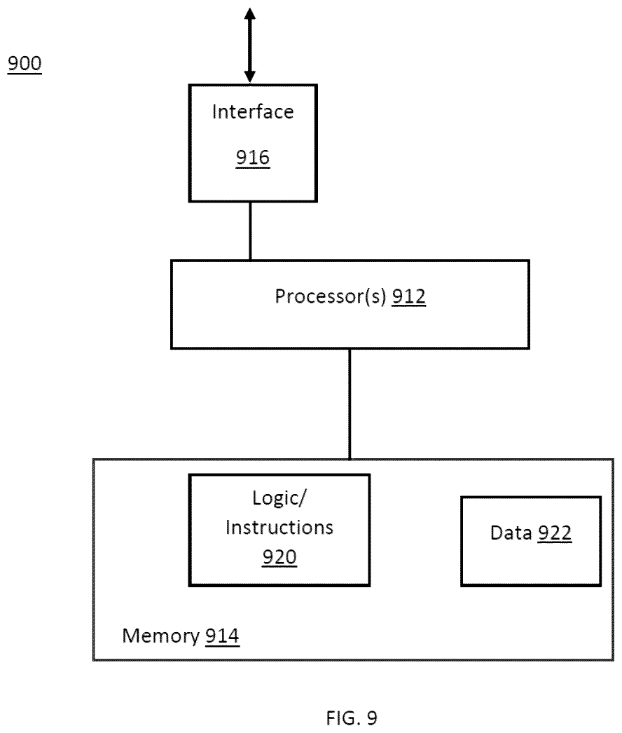

With reference to FIG. 9, there is a block diagram of a controller 900 according to an embodiment. Controller 900 may perform operations described herein, such as processing and trigger generation. Controller 900 may represent the microcontroller described above. Controller 900 includes a processor 912 (e.g., a microcontroller) (which may be implemented in hardware, software, or a combination thereof), a memory 914, and an interface 916 to receive signals from the current rate of change detector and to provide signals to the switch. The memory 914 may comprise read only memory (ROM), random access memory (RAM), magnetic disk storage media devices, optical storage media devices, flash memory devices, electrical, optical, or other physical/tangible memory storage devices. Thus, in general, the memory may comprise one or more tangible (non-transitory) computer readable storage media (e.g., a memory device) encoded with software comprising computer executable logic/instructions 920 and when the software is executed (by the controller) it is operable to perform the operations described herein.

Memory 914 also stores data 922 used and produced by processor 912. In embodiments, components of controller 900 may include electronic circuitry such as, for example, programmable logic circuitry, field-programmable gate arrays (FPGA), or programmable logic arrays (PLA) to execute the computer readable program instructions, which may include microcode, firmware, and so on.

As used herein, the term “connected to” (and similarly “coupled to”), unless specified otherwise, covers an arrangement in which components or terminals/nodes are directly connected to each other, and an arrangement in which the components or terminals/nodes are indirectly connected to each other through one or more intermediate components.

It is to be understood that the exemplary circuits and components disclosed herein are intended for the purpose of illustrating possible implementations of the present inventive concept, and are not restrictive. Many variants, modifications, and alternatives will become apparent to the skilled artisan upon review of this disclosure. For example, functional blocks described may be implemented with equivalent components, or fewer or more components, and achieve an equivalent output; and individually described methods may be combined. Therefore, the scope of the invention should be determined with reference to the appended claims, along with their full range of equivalents, and not with reference to the description above.

The above description is intended by way of example only.

What is claimed is:

1. A surge protector comprising:
a. a defined load (conductive element) which is configured between/across two electrical power supply conductors (power rails) that supply power to an output load also connected across the power rails so as to be connected in parallel with the output load;
b. an optional diode bridge;
c. a surge detection circuit including a component to detect a rate of change of current through the defined load;
d. a detector to detect a rate of change of current;
e. a generator to generate one or more switching control signals;
f. one or more switches controlled responsive to the one or more switching control signal(s) to control the switches into conductive, non-conductive, and/or semi-conductive states; and
g. the switches are configured to connect one or more electronic components in a conductive path between the two electrical power supply conductors.

2. A surge protector as in claim 1, wherein the defined load includes any of one or more capacitors, one or more diodes, one or more varistors, one or more resistors, and/or one or more gas discharge tubes.

3. A surge protector as in claim 1, wherein the switches include any of one or more Thyristors (SCR, TRIAC, DIAC, QUADRAC, etc.), one or more Transistors (Bipolar, MOSFET, IGBT, etc.), and/or one or more Electromechanical (Relays, Contactors, etc.).

4. A surge protector as in claim 1, wherein the current rate of change detection circuit includes an inductor.

5. A surge protector as in claim 1, wherein the surge protector further includes an inductor or resistor connected in series with at least one of the electrical power supply conductors.

6. A surge protector as in claim 5, wherein the surge protector further includes the diode bridge connected to the two electrical power supply conductors on the load side of the series inductor (or resistor); such that the monitored defined load, surge detection circuit, processing and control signal generating means, switches, and controlled components are connected between the positive and negative terminals of the diode bridge.

7. A surge protector as in claim 1, wherein the surge protector further includes a transformer connected to the electrical power supply conductors.

8. A surge protector as in claim 7, wherein the surge protector further includes the diode bridge connected to the two electrical power supply conductors on the load side of the transformer; such that the monitored defined load, surge detection circuit, processing and control signal generating means, switches, and controlled components are connected between the positive and negative terminals of the diode bridge.

9. A surge protector as in claim 1, wherein the current rate of change detection circuit includes a microcontroller or integrated circuit.

10. A surge protector as in claim 1, wherein the method of coupling the switching control signal(s) to the one or more switches includes an isolator (e.g., an optical isolator, RF isolator, pulse transformer, etc.).

11. A surge protector as in claim 1, wherein the surge protector further includes one or more computer readable storage media encoded with software comprising computer executable instructions and when the software is executed operable to perform operations shown and described herein.

12. A method for protecting electrical and electronic devices from a voltage surge comprises:
a. connecting a conductive element between two electrical power supply conductors.
b. connecting one or more controlled electronic components between two electrical power supply conductors.
c. connecting switch(es) in series with the controlled components.
d. determining a rate of change of current through the conductive element.
e. comparing the rate of change to a set of criteria.
f. controlling the switch(es) to connect one or more of the controlled electronic components in a conductive path between the two electrical power supply conductors if the comparison of the rate of change satisfies the criteria.

13. A surge protector for power supplied on power rails from a power input to an output load that is connected across the power rails and that is downstream from the power input, comprises:
a. first series-connected components including a defined load and a surge detector connected between the rails to be in parallel with the output load, wherein the surge detector is configured to derive a rate signal indicative of a rate of change of current that flows through the defined load;
b. second series-connected components including a surge reducer and a switch connected between the rails; and
c. a controller to control the switch responsive to the rate signal to:
i. when the rate signal is in a range indicative of a power surge, control the switch to enable the surge reducer to reduce the power surge.
ii. when the rate signal is not in the range, control the switch to disable the surge reducer.

14. A surge protector as in claim 13, wherein the surge protector further comprises a diode bridge connected across the power rails to convert AC power at the power input to rectified power, and to produce rectified power to opposing terminals of the diode bridge, wherein the surge protector is connected to the opposing terminals and configured to operate on the rectified power.

15. A surge protector as in claim 13, wherein the surge protector may further include an inductor or resistor connected in-line with one of the power rails between the power input and the output load, and the defined load and the surge detector are connected in series with each other between the inductor (or resistor) and the output load.

16. A surge protector as in claim 13, wherein the surge protector may further include a transformer connected between the power input and the output load, and the defined load and the surge detector are connected in series with each other between the transformer and the output load.
